(19) United States
(12) Patent Application Publication
(10) Pub. No.: US 2026/0008048 A1
(43) Pub. Date: Jan. 8, 2026

(54) POLYSILOXANE-BASED DEVICES WITH REDUCED DRUG ABSORPTION CHARACTERISTICS

(71) Applicant: THE JOHNS HOPKINS UNIVERSITY, Baltimore, MD (US)

(72) Inventors: Devon MAIR, Baltimore, MD (US); Marcus Alonso Cee WILLIAMS, Baltimore, MD (US); Jeffrey Fanzhi CHEN, Baltimore, MD (US); Deok Ho KIM, Seattle, WA (US)

(21) Appl. No.: 18/992,534

(22) PCT Filed: Jul. 11, 2023
(86) PCT No.: PCT/US2023/027410

§ 371 Date: Jan. 8, 2025

Related U.S. Application Data
(60) Provisional application No. 63/388,279, filed on Jul. 12, 2022.

(51) Int. Cl. B01L 3/00

(52) U.S. Cl. CPC B01L 3/502707; B01L 2200/12; B01L 2200/14; B01L 2300/0887; B01L 2300/12; B01L 2300/165

(57) ABSTRACT

Polysiloxane based microfluidic devices exhibiting significantly less drug absorption with addition of hydrophilic copolymer additive and/or pretreatment with therapeutic agent.

### CROSS-REFERENCE TO RELATED APPLICATIONS

This application claims priority to U.S. Provisional Application No. 63/388,279, filed Jul. 12, 2022, which is incorporated into this application by reference.

### GOVERNMENT RIGHTS

This invention was made with government support under grant 5UH3TR003519-05 awarded by the National Institute of Biomedical Imaging and Bioengineering. The government has certain rights in the invention.

### BACKGROUND

Polydimethylsiloxane (PDMS) is used to fabricate microphysiological, lab-on-a-chip, and microfluidic systems. This is due to the beneficial properties and characteristics of PDMS, including being bioinert, having excellent gas permeability, tunable stiffness, optical clarity, ease of use, and relatively low cost. Despite these benefits, PDMS's inherent hydrophobicity leads to challenges in its use for drug screening applications. This can result in inaccurate concentrations of differentiation factors, growth factors, and pharmaceuticals, which can lead to variable and inaccurate experimental results. Such problems have resulted in efforts to identify alternative materials or methods to modify PDMS to decrease these negative properties. Alternative materials include elastomers, hydrogels, and thermoplastic polymers, but the benefits of PDMS are difficult to find in one single material. Similarly, methods for preventing adsorption and absorption of small molecules, including the use of oxygen plasma and surface coatings, are limited by having low throughput, short lifespans, and low efficacy. Methods to decrease drug absorption can also compromise the desirable characteristics of PDMS, such as changing the Young's modulus or alter microfluidic channel geometry. This signifies the need for alternative methods.

### SUMMARY

One embodiment of the method for using the microfluidic device comprises: providing a microfluidic device comprising a microfluidic layer having at least one channel, the microfluidic layer obtainable by curing a mixture comprising a polysiloxane base polymer, a curing agent, and a poly(siloxane-ethylene oxide) copolymer; and contacting the at least one channel with a small-molecule therapeutic agent.

An embodiment of the microfluidic device comprises: a microfluidic layer having at least one channel, the microfluidic layer obtainable by curing a mixture comprising a polysiloxane base polymer, a curing agent, and a poly(siloxane-ethylene oxide) copolymer; and a therapeutic agent in the at least one channel, wherein the at least one channel is free of albumin, lysozyme, and immunoglobulin G.

### BRIEF DESCRIPTION OF THE DRAWINGS

The foregoing summary, as well as the following description of the disclosure, is better understood when read in conjunction with the appended drawings. For the purpose of illustrating the disclosure, the drawings illustrate some, but not all, alternative embodiments. This disclosure is not limited to the precise arrangements and instrumentalities shown. The following figures, which are incorporated into and constitute part of the specification, assist in explaining the principles of the disclosure.

FIG. 1A shows representative water contact angle images for exemplary PDMS samples with PDMS-PEG block copolymer additive.

FIG. 1B is a plot of water contact angle vs. % PDMS-PEG block copolymer additive, showing that increasing the percentage of block copolymer in the PDMS significantly reduces water contact angle, indicating a decrease in hydrophobicity. (**** denotes p≤0.0001).

FIGS. 2A-F show an experimental outline for drug absorption studies (FIG. 2A) and plots showing 1-week drug absorption (%) for samples with increasing percentage of block copolymer in the PDMS. FIG. 2B shows that Verapamil absorption is significantly reduced with both 1% and 2% block copolymer (BCP). FIG. 2C shows that Bepridil exhibits a downward trend with increased BCP concentration, but there is no significant improvement. FIG. 2D show that Quinidine absorption is significantly reduced with both 1% and 2% BCP. FIG. 2E shows that Terfenadine absorption is significantly reduced with both 1% and 2% BCP. FIG. 2F shows that Metoprolol absorption is significantly reduced with both 1% and 2% BCP. ns indicates p>0.05, * p≤0.05, ** p≤0.01, *** p≤0.001, **** p≤0.0001.

FIGS. 3A-B show that PDMS-PEG BCP prevents drug sequestration and absorption by allowing increased free flow of drug into and out of PDMS. FIG. 3A shows the experimental outline. FIG. 3B shows that increasing BCP concentration results in significant increases in the rate of drug effusion. FIG. 3C shows a schematic illustration of a model showing that BCP prevents drug sequestration, allowing free flow of drug into and out of the sample. * indicates p≤0.05, ** p≤0.01.

FIGS. 4A-F show that pretreating PDMS samples with higher dosages can further decrease drug absorption. FIG. 4A shows the experimental outline. FIG. 4B shows that pretreating PDMS and PDMS-PEG block copolymer (BCP) samples with verapamil at high dosages can further decrease drug absorption in all conditions. Effusion may occur in 1 mM pretreated 2% block copolymer (BCP). U=Untreated. FIG. 4C shows that pretreating with bepridil results in a decrease, followed by an increase in drug absorption as pretreatment dosage increase in PDMS and 1% BCP. Pretreating significantly decreases absorption with 1 mM dosage in 2% BCP. FIG. 4D shows that pretreating with higher dosages has minimal effects on quinidine absorption, with a decrease in absorption in 1 mM pretreated PDMS and an increase in absorption in 200 μM pretreated 2% BCP conditions. FIG. 4E shows that pretreating with increased dosages can further decrease terfenadine absorption. FIG. 4F shows that similar to bepridil, metoprolol exhibits a biphasic drug absorption pattern as pretreatment dosage is increased in PDMS. There is no significant change in absorption with pretreatment in 1% BCP, and a significant increase in absorption with 200 μM pretreated 2% BCP. ns indicates p>0.05, * p≤0.05, ** p≤0.01, *** p≤0.001, **** p≤0.0001.

FIGS. 5A-B show that drug absorption can be reduced using the optimized anti-absorption condition (APC). FIG. 5A shows a heatmap showing the fold change in drug absorption for each drug and condition tested. X-Axis indicates the block copolymer (BCP) concentration and drug pretreatment concentration. FIG. 5B shows a table summarizing the absorption preventing condition (APC) for each drug, the amount of drug lost to absorption in this condition, and the percent reduction compared to PDMS.

FIGS. 6A-D show that preventing drug absorption results in more accurate experimental results. FIG. 6A shows the experimental plan. FIG. 6B shows a representative image of an engineered heart tissue (EHT). FIG. 6C shows dose-response curves in EHTs for 1 μM verapamil, 1 μM verapamil after being incubated with our absorption preventing condition (APC), and 1 μM verapamil after being incubated with PDMS. FIG. 6D shows PDMS absorbed enough drug to significantly reduce the IC50 value compared to control and APC, while the IC50 of the APC is not significantly different from control. Statistically analyzed using a t-test. ns=P>0.05, **=P<0.01.

FIG. 7 shows sample Young's modulus as measured via tensile testing for 0%, 1%, and 2% block copolymer (BCP) conditions. Sample size equals 3 with three separate measurements for each sample. Statistically analyzed using a t-test. *=P≤0.05.

FIG. 8 shows a plot of drug absorption for verapamil, DI, and control at increasing percentages of block copolymer (BCP) additive.

FIGS. 9A-F are plots showing that pretreating PDMS samples with experimental dosages for 1 week can decrease drug absorption in some samples. FIG. 9A shows the experimental outline. FIG. 9B shows that pretreating PDMS and PDMS-PEG block copolymer (BCP) samples with verapamil significantly decreases verapamil absorption. U=untreated, P=pretreated. FIG. 9C shows that pretreating PDMS with bepridil significantly decreases bepridil absorption. FIG. 9D shows that pretreating has no significant effect on quinidine absorption. FIG. 9E shows that pretreating all PDMS variants with terfenadine significantly decreases terfenadine absorption. FIG. 9F shows that pretreating has no significant effect on metoprolol absorption. ns indicates p>0.05, * p≤0.05, **** p≤0.0001.

### DETAILED DESCRIPTION

### A. Definitions

When the term “about” precedes a numerical value, the numerical value can vary within +10% unless specified otherwise.

“Small molecule therapeutic agent” refers to a therapeutic agent having a molecular weight of 1,000 g/mol or less.

“Log P” refers to the partition coefficient of a molecule between aqueous and lipophilic phases, typically water and octanol. Log P can be determined by dissolving the compound in an immiscible biphasic system of lipophilic solvent and water in order to determine the proportion of solute dissolved in each phase.

“Polar surface area” refers to the polarity of a therapeutic agent, obtained by subtracting from the molecular surface the area of carbon atoms, halogens, and hydrogen atoms bonded to carbon atoms (i.e., nonpolar hydrogen atoms). In other words, the PSA is the surface associated with heteroatoms (namely oxygen, nitrogen, and phosphorous atoms) and polar hydrogen atoms.

A “cardiovascular drug” refers to any therapeutic agent that affects the function of the heart or blood vessels.

“Proarrhythmia” refers to the provocation of a new arrhythmia or the aggravation of a pre-existing one during therapy with a drug at doses or plasma concentrations below those considered to be toxic. Criteria for proarrhythmia include (1) the new appearance of a sustained ventricular tachyarrhythmia; (2) change from a nonsustained to a sustained tachyarrhythmia; (3) acceleration of tachycardia rate; or (4) the new appearance of a clinically significant bradyarrhythmia or conduction defect.

### B. Devices and Methods

Absorption of therapeutic agents by polysiloxane-based polymers such as PDMS in microfluidic devices can lead to erroneous experimental results. To mitigate these problems, the inventors identified copolymer additives and drug pretreatment embodiments as efficacious methods for nearly eliminating absorption of drug compounds. The disclosed devices and methods enable accurate drug screening experiments.

The disclosed methods can be used with a wide variety of microfluidic and other devices. The polysiloxane-copolymer mixture can be a cured layer of any suitable device which comes into contact with a therapeutic agent, including microfluidic devices, macro-devices, tissue chambers, and the like.

Typically, a microfluidic device will include at least one channel capable of constraining a fluid to a small scale (e.g., sub-millimeter), where surface forces tend to dominate volumetric forces. In some embodiments, the microfluidic device has at least one microfluidic layer having at least one channel with a sub-millimeter diameter, e.g., a diameter of 1 mm or less, such as 10-1,000 μm. Specific examples of devices include those with at least on microfluidic layer having at least one channel with a diameter ranging from 10-500 μm. Specific non-limiting applications of the microfluidic devices include molecular in separation, biosensors, biochemical assays, drug screening, chromatography, migration assays, lab-on-a-chip applications, organ-on-a-chip applications, in addition to high-throughput screening applications. In one specific aspect, the microfluidic device can mimic a cardiac microphysiological system and can be used to screen cardiovascular drugs.

In some embodiments, the microfluidic layer can be obtained by curing a mixture comprising a polysiloxane base polymer, a curing agent, and a poly(siloxane-ethylene oxide) copolymer. The addition of the poly(siloxane-ethylene oxide) copolymer will decrease the hydrophobicity of the microfluidic layer and thereby attenuate unwanted drug absorption during use of the microfluidic device.

In some embodiments, prior to curing, the mixture comprises the poly(siloxane-ethylene oxide) copolymer in an amount of 20% or less by weight of the mixture, e.g., from 1-20% by weight. In a further embodiment, prior to curing, the mixture comprises the poly(siloxane-ethylene oxide) copolymer in an amount of 15% or less by weight of the mixture. In a further embodiment, prior to curing, the mixture comprises the poly(siloxane-ethylene oxide) copolymer in an amount of 10% or less by weight of the mixture. In a further embodiment, prior to curing, the mixture comprises the poly(siloxane-ethylene oxide) copolymer in an amount of 8% or less by weight of the mixture. In a further embodiment, prior to curing, the mixture comprises the poly(siloxane-ethylene oxide) copolymer in an amount of 6% or less by weight of the mixture. In a further embodiment, prior to curing, the mixture comprises the poly(siloxane-ethylene oxide) copolymer in an amount of 5% or less by weight of the mixture. In a further embodiment, prior to curing, the mixture comprises the poly(siloxane-ethylene oxide) copolymer in an amount of 4% or less by weight of the mixture. In a further embodiment, prior to curing, the mixture comprises the poly(siloxane-ethylene oxide) copolymer in an amount of 3% or less by weight of the mixture. In a further embodiment, prior to curing, the mixture comprises the poly(siloxane-ethylene oxide) copolymer in an amount of 2% or less by weight of the mixture. In a specific embodiment, prior to curing, the mixture comprises the poly(siloxane-ethylene oxide) copolymer in an amount of 1-2% by weight of the mixture. In one embodiment, prior to curing, the mixture comprises 0.5-5% by weight of the poly(siloxane-ethylene oxide) copolymer.

With the desired amount of polysiloxane base polymer and the poly(siloxane-ethylene oxide) copolymer, the polysiloxane microfluidic device can be made according to methods known in the art. Typically, the ratio of the polysiloxane base polymer and curing agent (i.e., crosslinking agent) will be present in the mixture prior to curing at a ratio ranging from 10:1 to 1:10. To form the microfluidic device using soft lithography, the mixture can be poured into a suitable master mold having desired microfluidic features, cured, and then released to provide a polysiloxane based device that replicates the master mold. Other known methods of forming the microfluidic devices are also contemplated.

Typical uses of the microfluidic device include those in which the at least one channel of the microfluidic layer is contacted with a small-molecule therapeutic agent. In some aspects, the use does not involve a larger biomolecule. Thus, in some embodiments, the at least one channel is not contacted with albumin, lysozyme, or immunoglobulin G. In other embodiments, the at least one channel is not contacted with any protein.

In some embodiments, the polysiloxane base polymer is polydimethylsiloxane (PDMS). In one embodiment, the poly(siloxane-ethylene oxide) copolymer is a poly(dimethylsiloxane-ethylene oxide) copolymer. In a further embodiment, the poly(dimethylsiloxane-ethylene oxide) copolymer has a molecular weight ranging from 200-5,000 g/mol. In one specific embodiment, the poly(dimethylsiloxane-ethylene oxide) copolymer has the structure:

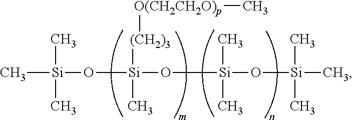

wherein m, n, and p are independently non-zero integers. In one example, this poly(dimethylsiloxane-ethylene oxide) copolymer has a molecular weight ranging from 500-700 g/mol.

Other embodiments describe a microfluidic device comprising: a microfluidic layer having at least one channel, the microfluidic layer obtainable by curing a mixture comprising a polysiloxane base polymer, a curing agent, and a poly(siloxane-ethylene oxide) copolymer; and a therapeutic agent in the at least one channel, wherein the at least one channel is free of albumin, lysozyme, and immunoglobulin G.

It is contemplated that some embodiments of the microfluidic device can be in use, i.e., with one or more fluids in the at least one channel of the microfluidic layer. In addition, in some embodiments, the therapeutic agent in the at least one channel is diffused into the microfluidic layer itself and the microfluidic device as a whole is substantially dry or dry of fluid. It is contemplated that this embodiment can be used as a pre-treated microfluidic device which due to the preloading of therapeutic agent into the operative channel, can further attenuate drug absorption into the at least one channel. Thus, in some aspects, prior to contacting the at least one channel with the therapeutic agent, the at least one channel can be pretreated with the small-molecule therapeutic agent at a concentration that is equal to or greater than the concentration used during the contacting step.

In various embodiments, the small-molecule therapeutic agent will have a molecular weight of 1,000 g/mol or less. In one aspect, the small-molecule therapeutic agent has a molecular weight of 900 g/mol or less. In another aspect, the small-molecule therapeutic agent has a molecular weight of 800 g/mol or less. In another aspect, the small-molecule therapeutic agent has a molecular weight of 700 g/mol or less. In another aspect, the small-molecule therapeutic agent has a molecular weight of 600 g/mol or less. In another aspect, the small-molecule therapeutic agent has a molecular weight of 500 g/mol or less. In a further aspect, the small-molecule therapeutic agent has a molecular weight of 200-500 g/mol. In a further aspect, the small-molecule therapeutic agent has a molecular weight of 250-500 g/mol. In a further aspect, the small-molecule therapeutic agent has a molecular weight of 300-500 g/mol. In a further aspect, the small-molecule therapeutic agent has a molecular weight of 267-472 g/mol.

Without wishing to be bound by theory, it is thought that the hydrophobic or hydrophilic nature of the small-molecule therapeutic agent affects its absorption into a polysiloxane-based microfluidic device. In one aspect, the small-molecule therapeutic agent has a Log P of 7 or less, e.g., 6 or less, 5 or less, 4 or less, 3 or less, or 2 or less. Solubility of the small-molecule therapeutic agent may also in some aspects be important. In some embodiments, the small-molecule therapeutic agent has a solubility (mg) in water (mL) of 1,000 mg/mL or less, e.g., 900 mg/mL or less, 800 mg/mL or less, 700 mg/mL or less, 600 mg/mL or less, 500 mg/mL or less, 400 mg/mL or less, 300 mg/mL or less, 200 mg/mL or less, 100 mg/mL or less, 50 mg/mL or less, 25 mg/mL or less, 20 mg/mL or less, 18 mg/mL or less, 16 mg/mL or less, 14 mg/mL or less, 12 mg/mL or less, 10 mg/mL or less, 8 mg/mL or less, 6 mg/mL or less, 4 mg/mL or less, 2 mg/mL or less, 1 mg/mL or less, 0.5 mg/mL or less, 0.4 mg/mL or less, 0.3 mg/mL or less, 0.2 mg/mL or less, 0.1 mg/mL or less, including small-molecule therapeutic agents that are substantially insoluble to insoluble in water.

In some embodiments, the small-molecule therapeutic agent can have a polar surface area of 10-100, e.g., 10-80, 10-70, 15-70, e.g., 15.7-64, including for example 15.7, 43.7, 45.6, 50.7, and 64. In some embodiments, the small-molecule therapeutic agent is a cardiovascular drug. Non-limiting examples include an anticoagulant, an antiplatelet agent, an ACE inhibitor, an angiotensin receptor-neprilysin inhibitor, a beta blocker, a calcium channel blocker, a cholesterol-lowering agent, a diuretic, or a vasodilator.

### C. Examples

The following examples further illustrate this disclosure. The scope of the disclosure and claims is not limited by the scope of the following examples.

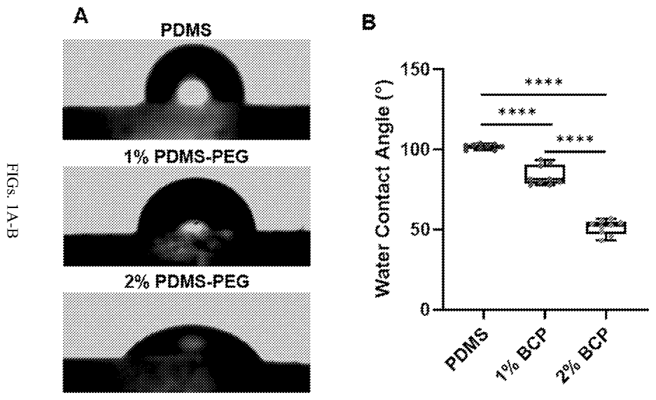

As PDMS drug absorption is linked to its hydrophobicity, we evaluated whether PDMS-PEG additive decreases the hydrophobicity by measuring the sessile drop water contact angle (WCA), an indication of surface free energy, on PDMS and PDMS-PEG block copolymer samples. A material is canonically considered hydrophobic with a WCA of >90°, and hydrophilic with a WCA of <90°. We found that increasing PDMS-PEG concentrations led to significantly reduced WCAs (FIG. 1). Standard PDMS had a mean WCA of ˜100°, which was reduced to ˜50° with 2% PDMS-PEG block copolymer additive. This confirms that PDMS-PEG block copolymer increases the hydrophilicity of the resulting polymer.

To test whether increased hydrophilicity translated to decreased absorption of drug compounds, we selected five drugs from the Comprehensive in vitro Proarrhythmia Assay (CiPA) drug compound list with a wide range of chemical properties (Table 1). PDMS absorption is believed to be best predicted by the Log P value. The Log P value is a constant defined as the log of the partition coefficient, with larger values indicating a higher lipophilicity, and lower or negative values indicating a higher hydrophilicity. The Log P values of the drugs we selected ranged from 1.9 to 6.6. One chemical property alone, however, was not enough to predict the absorption of drug compounds by PDMS, and our drug compound list contained high ranges of molecular weight, solubility, polar contact area, and other properties that may influence drug absorption. There was no correlation between each drug property mentioned and drug absorption characteristics.

TABLE 1

| | Verapamil³⁵ | Bepridil³⁶ | Quinidine³⁷ |
|---|---|---|---|
| Molecular | 454.6 | 366.5 | 324.4 |
| Weight | | | |
| (g/mol) | | | |
| logP | 4.12 | 5.2 | 2.9 |
| Solubility in | Practically | 0.05655 | 0.14 |
| H₂O | Insoluble | | |
| (mg/mL) | | | |
| Polar | 64 | 15.7 | 45.6 |
| Surface | | | |
| Area | | | |
| Chemical Structure | 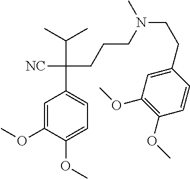 [SMILES: COc1ccc(CCN(C)CCCC(C#N)(c2ccc(OC)c(OC)c2)C(C)C)cc1OC] | 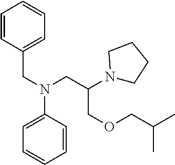 [SMILES: CC(C)COCC(CN(Cc1ccccc1)c1ccccc1)N1CCCC1] | 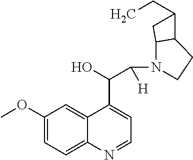 [SMILES: CCC1CC2C1CCN2CC(O)c1ccnc2ccc(OC)cc12] |
| Use | Pan-calcium | Pan-calcium | Cinchona |
| | channel | channel blocker, | alkaloid |
| | blocker | antihypertensive | antiarrhythmic |
| | | Metoprolol | |
| | | Succinate³⁸ | Terfenadine³⁹ |
| | Molecular | 267.36 | 471.7 |
| | Weight | | |
| | (g/mol) | | |
| | logP | 1.9 | 6.6 |
| | Solubility in | 1000 | 0.0963 |
| | H₂O | | |
| | (mg/mL) | | |
| | Polar | 50.7 | 43.7 |
| | Surface | | |
| | Area | | |
| | Chemical Structure | 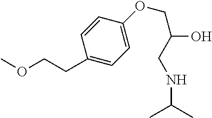 [SMILES: COCCc1ccc(OCC(O)CNC(C)C)cc1] | 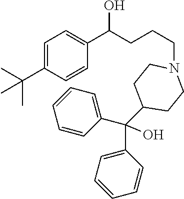 [SMILES: CC(C)(C)c1ccc(C(O)CCCN2CCC(C(O)(c3ccccc3)c3ccccc3)CC2)cc1] |
| | Use | Cardioselective β | Histamine H1- |
| | | 1-adrenergic | receptor |
| | | receptor | antagonist |
| | | antagonist, | |
| | | antihypertensive | |

(35) National Center for Biotechnology Information (2022). PubChem Compound Summary for CID 2520, Verapamil. Retrieved June 15, 2022 from https://pubchem.ncbi.nlm.nih.gov/compound/Verapamil. (36) National Center for Biotechnology Information (2022). PubChem Compound Summary for CID 2351, Bepridil. Retrieved June 15, 2022 from https://pubchem.ncbi.nlm.nih.gov/compound/Bepridil. (37) National Center for Biotechnology Information (2022). PubChem Compound Summary for CID 441074, Quinidine. Retrieved June 15, 2022 from https://pubchem.ncbi.nlm.nih.gov/compound/Quinidine. (38) National Center for Biotechnology Information (2022). PubChem Compound Summary for CID 62937, Metoprolol succinate. Retrieved June 15, 2022 from https://pubchem.ncbi.nlm.nih.gov/compound/Metoprolol-succinate. (39) National Center for Biotechnology Information (2022). PubChem Compound Summary for CID 5405, Terfenadine. Retrieved June 15, 2022 from https://pubchem.ncbi.nlm.nih.gov/compound/Terfenadine.

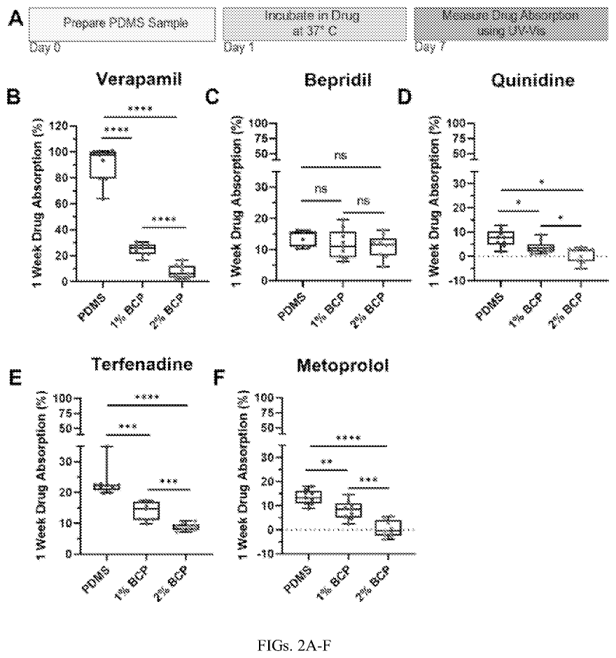

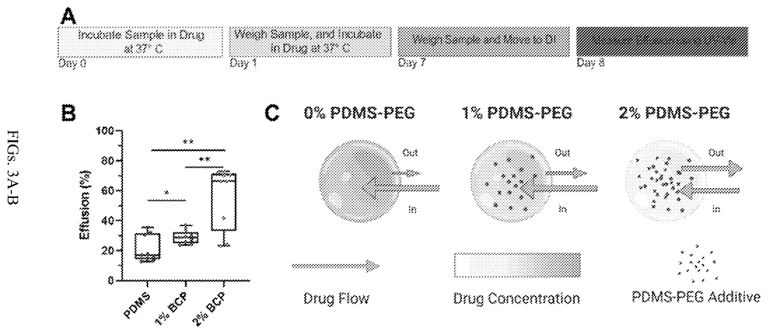

PDMS plugs, composed of 0%, 1%, or 2% PDMS-PEG block copolymer additive, were placed in 100 μM drug solutions and incubated at 37° C. for 1 week. Plug size was chosen to be similar to many microfluidic devices. After 1 week, the drug concentration was measured using UV-Vis spectroscopy, the area under the curve (AUC) was calculated, and each value was compared to drug standards to determine the percent drug loss (FIG. 2A). PDMS-PEG block copolymer additives decreased drug absorption for verapamil (91.5% reduction), quinidine (91.7% reduction), terfenadine (61.8% reduction), and metoprolol succinate (97.2% reduction), (FIGS. 2B-F).

While drug absorption is largely thought to be due to hydrophobic interactions, passive diffusion from areas of high concentration (the drug solution) to areas of low concentration (the PDMS sample) could also be responsible for drug absorption by PDMS. However, PDMS absorbed over 90% of verapamil, reversing this concentration gradient. This led us to hypothesize that PDMS-PEG block copolymer all allows for free flow of fluids into and out of the sample, while PDMS absorbs and sequesters drug compounds. In the case of verapamil, this means that PDMS sequesters verapamil but PDMS-PEG block copolymer allows drug to be released back into the media as the concentration equalizes.

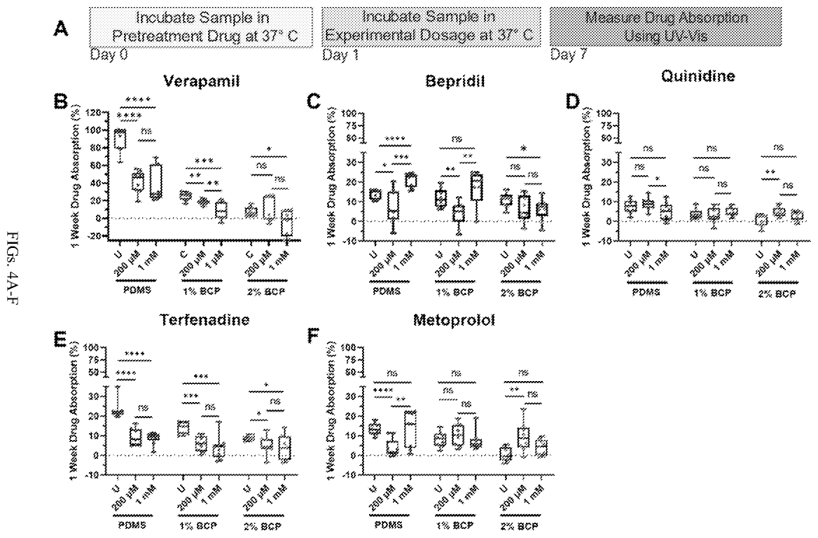

We incubated PDMS and PDMS-PEG block copolymer samples at 37° C. for 1 week in verapamil, transferred the samples to DI for 24 hours, and allowed the absorbed verapamil to effuse back out (FIG. 3A). We measured the amount of drug absorbed over the course of the week, and then measured the percent of drug absorbed by the PDMS that then effused into DI. We found that effusion was significantly higher in both 1% and 2% PDMS-PEG block copolymer samples, with 2% releasing over 50% of drug absorbed back into solution in 24 hours (FIG. 3B). Thus, PDMS-PEG block copolymer allows for free flow of drug into and out of the samples, rather than sequestering drug, decreasing the total percent drug absorbed, shown visually in FIG. 3C.

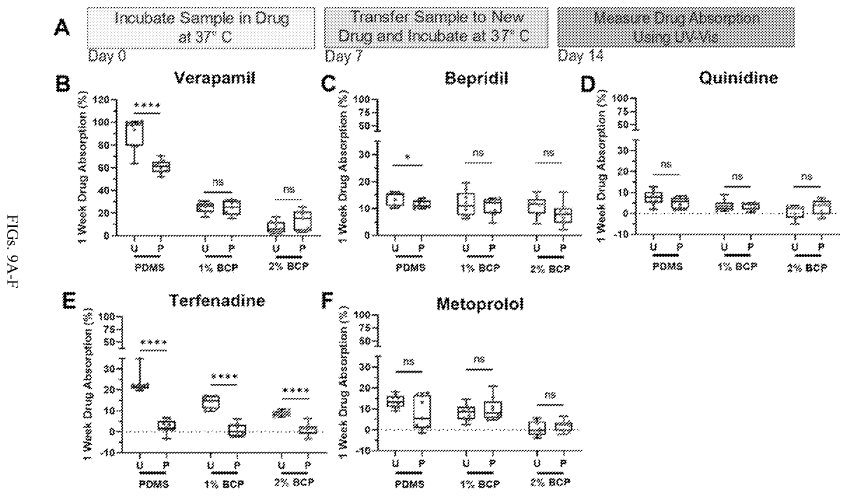

The decreased sequestration of drug compounds by PDMS-PEG block copolymer leads to an increased susceptibility to drug diffusion down concentration gradients. Negating this gradient would lead to less drug absorption in PDMS-PEG block copolymer samples. Drug pretreatment for 24 hours or with deionized water had no significant effect on drug absorption (FIG. 8), but drug pretreatment for one week had some small impact for certain drugs (FIG. 9). Drug pretreatment decreased absorption only in PDMS, and not PDMS-PEG block copolymer, samples due to the higher initial absorption of drug compounds during the pretreatment steps. Samples were pretreated with higher than experimental dosages to increase the concentration present within the PDMS-PEG block copolymer samples and decrease diffusion-driven drug absorption.

This higher initial drug concentration would benefit PDMS-PEG block copolymer samples in particular, as PDMS-PEG block copolymer does not sequester absorbed drug, allowing for flow of drug down concentration gradients. We pretreated with 200 μM and 1 mM concentrations and 1 week of absorption was measured (FIG. 4A). Among the benefits of using PDMS-PEG block copolymer additives to prevent absorption is the ease and minimal additional steps. While 1 day of pretreatment was insufficient using experimental dosages, pretreatment with higher dosages may allow for shorter pretreatment times. For these experiments, we utilized a 24 hour pretreatment step.

Pretreating with higher than experimental dosages led to significant reductions in drug absorption in verapamil, bepridil, terfenadine, and metoprolol samples. Unexpectedly, absorption of drug compounds was increased in bepridil PDMS and 1% PDMS-PEG block copolymer conditions, quinidine 2% PDMS-PEG block copolymer 200 μM pretreatment, and in metoprolol PDMS 1 mM and 2% PDMS-PEG block copolymer 200 μM pretreatment conditions. We also found 2% PDMS-PEG block copolymer eluted verapamil, showing that increased pretreatment dosages can cause drug release. These dynamics appear to be largely independent of the chemical properties considered.

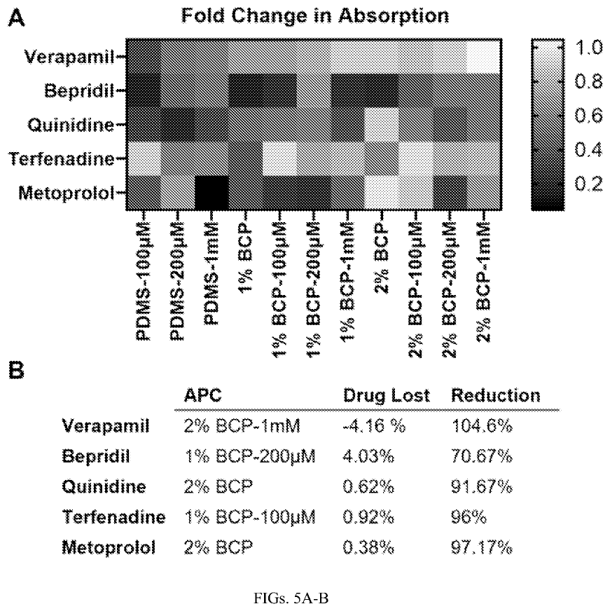

We instead identified an optimized Absorption Preventing Condition (APC) for each drug. We mapped the fold change for each experimental condition (FIG. 5A), and determined the condition that best prevented absorption for each compounds tested (FIG. 5B). In the identified APCs, the mean drug absorbed for all drug compounds was 0.36% (SEM of 1.31%), with a mean reduction of 91.63% (SEM of 5.49% %), essentially eliminating drug absorption for all drug compounds tested. These methods together prevent drug absorption with a maximum of a 24-hour incubation step and no complex processes, allowing for mass adoption.

Alternatively, 2% block copolymer addition with physiological dose pretreatment is capable of decreasing absorption by 73.66% (SEM of 10.02%) across all drug compounds tested without the possibility of eluting drug into the media. This can serve as a user-friendly, optimization-free condition for decreasing drug absorption significantly without the need for drug absorption experimental quantification to identify the APC.

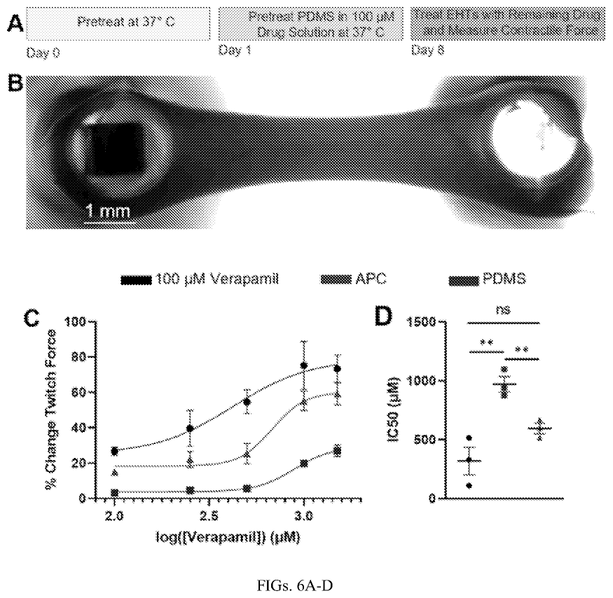

We tested whether the APC identified for verapamil would result in an accurate drug response. We utilized the commercially available Mantarray (Curi Bio) engineered heart tissue (EHT) platform to perform these screens. In this platform, the EHT self assembles between two posts, one soft and bendable, and the other stiff and immovable (FIG. 6B). The soft post has an embedded magnet, and deflection of the post due to EHT contraction results in changes in magnetic flux. The tissues can be placed over magnetic sensor arrays in the Mantarray system to measure this change in flux and calculate the twitch forces and kinetics.

We first incubated verapamil at 37° C. with PDMS, the APC, or without any sample for 1 week prior to initiating the drug response experiment (FIG. 6A). We chose this method, rather than direct treatment and absorption in device, for several reasons. First, verapamil was chosen as it had the largest reduction of all drug compounds tested, from over 90% drug absorption to essentially 0% absorption for the APC. Second, verapamil is a fast-acting pan calcium channel blocker which quickly inhibits contraction, which will occur much more rapidly than drug absorption occurs. Third, the surface area to volume ratio can be accurately set and modulated. Finally, this method greatly increases the signal to noise ratio by allowing drug to be absorbed for 1 full week prior to adding it to the tissues.

After drug was allowed to absorb for 1 week, dose response curves were measured for each condition. The APC condition is similar to the positive control, in which the exact dosage of drug is added, than the PDMS condition (FIG. 6C). We calculated the IC50 based on these dose response curves and found that the IC50 of PDMS-absorbed drug is significantly higher than both the positive control and APC conditions, while the APC is not statistically different from the positive control (FIG. 6D). The decreased absorption in the APC condition allows for more accurate drug screens and accurate measurements of physiological dose response.

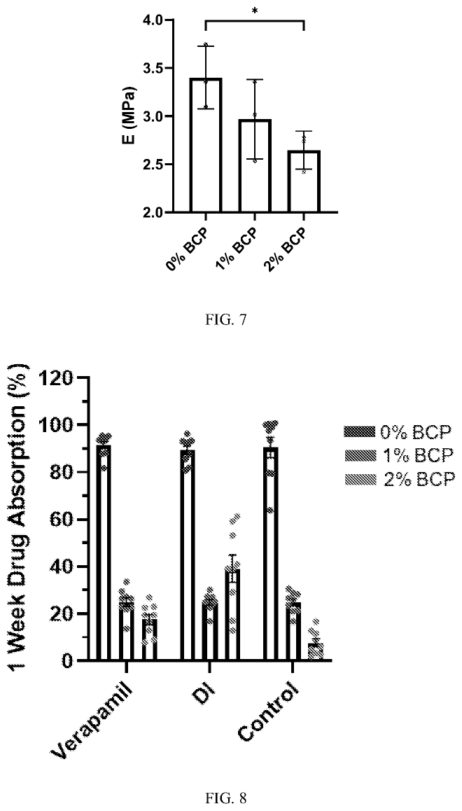

Dog bone tensile test samples meeting ASTM standards were fabricated using a PDMS mold pretreated with trichloroperfluoroctylsilane to prevent sticking of the PDMS sample. Samples were loaded on an MTS tensile testing machine and a standard tensile test was performed until fracture. The Young's Modulus was calculated as the slope of the stress-strain curve. Only samples in which fracture occurred in the gauge section were utilized in this calculation. See FIG. 7.

Pharmaceutical Selection: The panel of pharmaceutical compounds was selected from the CiPA list of drugs of interest based on their diverse chemical properties. The chemical properties of these compounds, found in Table 1, range widely. Solubility, which can be used as an indication of hydrophobicity, ranged from practically insoluble to 1000 mg/mL for verapamil and metoprolol succinate, respectively. Log P values, commonly thought to best predict solubility in two immiscible solvents, varied less between the compounds.

PDMS-PEG Fabrication: PDMS was prepared as previously described in Scott, L. E., Mair, D. B., Narang, J. D., Feleke, K. & Lemmon, C. A. Fibronectin fibrillogenesis facilitates mechano-dependent cell spreading, force generation, and nuclear size in human embryonic fibroblasts. Integrative Biology 7, 1454-1465 (2015). PDMS base was mixed with PDMS crosslinker at a 1:10 ratio for 5 minutes and was then degassed in a desiccator for 30 minutes. For the PDMS-PEG block copolymer additive conditions, PDMS-PEG block copolymer (Gelest, DBE-712) was added at the weight percentage indicated and mixed in with the PDMS base and crosslinker. Total weight of the composite was 15.5 g, which resulted in PDMS 15 mm thick. 8 mm plugs were taken using a biopsy punch and used in downstream experiments. This height/diameter was chosen to provide a surface to volume ratio of ˜0.2/mm, similar to that found in microfluidic devices.

Drug absorption experimental setup: Samples were added to glass vials. A 1.5 mL volume of 100 μM pharmaceutical solution was added, and the samples were fully submerged in the solution. This high dosage was chosen to increase the signal to noise ratio, as UV-Vis measurements of drug concentration were found to result in a relatively high degree of noise. Samples were incubated at 37° C. for one week, and drug concentration was measured using UV-Vis spectroscopy. Experimental samples were compared to controls, in which drug was incubated for one week without a PDMS sample. The mean of the controls was taken as the total drug concentration without absorption, and the percent drug loss was calculated as

$$\frac{mean control - mean experimental}{mean control} * 100.$$

Controls and experimental conditions were run as three independent technical replicates.

UV-Vis: Following experimental absorption, 2 μL samples were measured (Nanodrop 2000, ThermoFisher Scientific). Measurements were taken in triplicate for each sample to decrease noise. Each drug had a peak spectrum between 190 and 300 nm. The area under the curve (AUC) given by the spectra was calculated between 190 and 300 nm and compared to a standard curve generated by known concentrations of each compound in deionized water. The area under the curve was used to calculate the precent drug loss, compared to the AUC of the drug standards. Sample size equals three, with three independent measurements per sample.

Water Contact Angle Measurements: PDMS plugs were fabricated and taken as mentioned previously. WCA was measured using a Ramé-Hart goniometer. Samples were placed on the pedestal, and 2 μL volume deionized water, a volume chosen to avoid the flattening effect due to gravity of large droplets, was manually pipetted onto the sample. Pictures were taken of the water droplet within 5 seconds of droplet contact. The static contact angle was measured on the captured image using an ImageJ plug-in. Sample size equals nine.

Drug Effusion Experimental Methods: PDMS, 1% block copolymer, and 2% block copolymer samples were prepared as mentioned above, and allowed to absorb drug for one week. Following one week of drug absorption, the PDMS samples were moved into deionized water and incubated at 37° C. for one week. Following one day of drug effusion out of the saturated PDMS into the deionized water, the solution was measured using UV-Vis and compared to a standard curve. Sample size equals three, with three independent measurements per sample.

Drug Pretreatment: PDMS, 1% block copolymer, and 2% block copolymer samples were prepared as mentioned above. Samples were incubated at 37° C. for 1 week (FIG. 9) or 1 day (FIG. 4) in 100 μM, 200 μM, or 1 mM drug, as described for each experiment. Pretreated samples were then transferred to a fresh 100 μM drug solution for one week of absorption, and absorption was assessed as described.

Stem cell differentiation and characterization: The JHU-001 hiPSC line was cultured and differentiated as previously described in RN, H. et al. Altered Electrical, Biomolecular, and Immunologic Phenotypes in a Novel Patient-Derived Stem Cell Model of Desmoglein-2 Mutant ARVC. Journal of clinical medicine 10, (2021). Stem cells were cultured on tissue culture plastic that was precoated with 1:200 diluted Geltrex in Essential 8 medium (ThermoFisher Scientific). Cardiogenic differentiation was accomplished through small molecule modulation of Wnt signaling in RPMI1640 media with B-27 minus insulin (ThermoFisher Scientific). Following Wnt modulation, media was changed to RPMI1640 with B-27. Beginning at day 14, hiPSC derived cardiomyocytes underwent 4 days of lactate purification in glucose-free and glutamine-free DMEM supplemented with 4 mM L-lactate (MilliporeSigma). Cardiomyocytes were used for casting of EHTs between day 20 and 25 following initiation of differentiation.

Engineered Heart Tissue Fabrication: The Mantarray (Curi Bio) is a system designed for reproducible fabrication and functional measurements of EHTs in a 24-well plate format. EHTs were fabricated as described by Mantarray casting protocols. The post arrays and casting plates were sterilized, and posts were incubated with first polyethylenimine (Sigma Aldrich) and then glutaraldehyde to facilitate tissue attachment. 50 μL of 6 U/mL human thrombin (Sigma Aldrich) was added to the casting wells, which were kept on ice until casting. Cardiomyocytes and HS27A stromal cells (ATCC) were lifted using 0.05% trypsin+EDTA, counted, and resuspended at 8.3 million cells/mL and 2.5 million cells/mL, respectively. A cell-fibrinogen solution was prepared by mixing 30 μL stromal cells, 60 μL cardiomyocytes, and 10 μL of 50 mg/mL human fibrinogen (Sigma Aldrich) for each tissue. Post arrays were placed in the casting wells, and this cell solution was mixed with the thrombin solution quickly. The plates were incubated at 37° C. for 80 minutes, and 100 μL of culture media was added on the tissues. The culture media consisted of RPMI1640 and was supplemented with B27 and aminocaproic acid to inhibit fibrinolytic activity. After 10 minutes, the tissues were removed from the casting wells and placed into a new plate with fresh media. All tissues were cultured for 3 weeks prior to experiments.

EHT Dosing and Contractile Measurements: EHTs were fabricated as described above and paced to measure average force output. Prior to pacing, EHTs were incubated with a commercially available 24 well plate stimulation apparatus (Mantarray Stimulation Plate, Curi Bio) with electrodes inserted into the media at 37° C. 5.0% CO₂ for three hours to allow for the electrodes to equilibrate to 37° C. EHTs were paced at 5.0 V 1 Hz with a pulse duration of 10 milliseconds and average force output readings were recorded using a Mantarray for 60 seconds to give an initial mean force average. IC50 curves were then generated by dosing the EHTs with either 30 μL (final concentration 1500 nM), 20 μL (final concentration 1000 nM), 10 μL (final concentration 500 nM), 5 μL (final concentration 250 nM) or 2 μL (final concentration 100 nM) of a 100 μM solution of Verapamil (n=3 for all doses). Immediately following dosage, the tissues were then paced as described above and the mean twitch force was calculated from a 60 second recording. EHTs were dosed in the same manner, paced, and recorded with equivalent volumes of 100 μM Verapamil at each concentration after being exposed to PDMS for one week at 37° C. for both the optimized APC (2% block copolymer-1 mM) and PDMS alone (n=3 for all dosages). Percent reduction in twitch force following exposure to drug was then calculated using the equation

$$100 - \frac{mean force after drug}{mean force before drug} * 100.$$

Sample size equals three for each dosage.

Statistical Methods: Student t-tests were performed using GraphPad Prism version 9.0 for Windows, GraphPad Software, San Diego, California. For the boxplots in the figures, the upper and lower hinges represent the third and first quartiels, the center bar represents the median of the population, and the whiskers show a 1.5× interquartile range. Sample sizes or numbers of independent experiments described in each experimental methods section. Significance levels were indicated in the figure legends.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other methods and systems for carrying out the several purposes of this disclosure. As a result, the claims should not be considered as limited by the description or examples.

What is claimed is:

1. A method for using a microfluidic device, the method comprising:
a) providing a microfluidic device comprising a microfluidic layer having at least one channel, the microfluidic layer obtainable by curing a mixture comprising a polysiloxane base polymer, a curing agent, and a poly(siloxane-ethylene oxide) copolymer; and
b) contacting the at least one channel with a small-molecule therapeutic agent.

2. The method of claim 1, wherein the at least one channel is not contacted with albumin, lysozyme, or immunoglobulin G.

3. The method of claim 1, wherein the at least one channel is not contacted with any protein.

4. The method of claim 1, wherein prior to curing, the mixture comprises 0.5-5% by weight of the poly(siloxane-ethylene oxide) copolymer.

5. The method of claim 1, wherein the polysiloxane base polymer is polydimethylsiloxane (PDMS).

6. The method of claim 1, wherein the poly(siloxane-ethylene oxide) copolymer is a poly(dimethylsiloxane-ethylene oxide) copolymer.

7. The method of claim 6, wherein the poly(dimethylsiloxane-ethylene oxide) copolymer has a molecular weight ranging from 200-5,000 g/mol.

8. The method of claim 6, wherein the poly(dimethylsiloxane-ethylene oxide) copolymer has the structure: 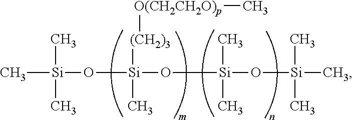
wherein m, n, and p are independently non-zero integers.

9. The method of claim 8, wherein the poly(dimethylsiloxane-ethylene oxide) copolymer has a molecular weight ranging from 500-700 g/mol.

10. The method of claim 1, wherein the small-molecule therapeutic agent has a molecular weight of 500 g/mol or less.

11. The method of claim 1, wherein the small-molecule therapeutic agent has a molecular weight ranging from 300-500 g/mol.

12. The method of claim 1, wherein the small-molecule therapeutic agent is a cardiovascular drug.

13. The method of claim 12, wherein the cardiovascular drug is an anticoagulant, an antiplatelet agent, an ACE inhibitor, an angiotensin receptor-neprilysin inhibitor, a beta blocker, a calcium channel blocker, a cholesterol-lowering agent, a diuretic, or a vasodilator.

14. The method of claim 1, further comprising, prior to step b), pretreating the at least one channel with the small-molecule therapeutic agent at a concentration that is equal to or greater than the concentration used during step b).

15. A microfluidic device comprising:
a) a microfluidic layer having at least one channel, the microfluidic layer obtainable by curing a mixture comprising a polysiloxane base polymer, a curing agent, and a poly(siloxane-ethylene oxide) copolymer; and
b) a therapeutic agent in the at least one channel, wherein the at least one channel is free of albumin, lysozyme, and immunoglobulin G.

16. The microfluidic device of claim 15, wherein the at least one channel is free of any protein.

17. The microfluidic device of claim 15, wherein prior to curing, the mixture comprises 0.5-5% by weight of the poly(siloxane-ethylene oxide) copolymer.

18. The microfluidic device of claim 15, wherein the polysiloxane base polymer is polydimethylsiloxane (PDMS).

19. The microfluidic device of claim 15, wherein the poly(siloxane-ethylene oxide) copolymer is a poly(dimethylsiloxane-ethylene oxide) copolymer.

20. The microfluidic device of claim 19, wherein the poly(dimethylsiloxane-ethylene oxide) copolymer has a molecular weight ranging from 200-5,000 g/mol.
